(19) United States
(12) Patent Application Publication
(10) Pub. No.: US 2010/0263639 A1
(43) Pub. Date: Oct. 21, 2010

(54) Engine Control Method and System

(75) Inventors: Michael James Uhrich, West Bloomfield, MI (US); Gopichandra Surnilla, West Bloomfield, MI (US)

Correspondence Address: ALLEMAN HALL MCCOY RUSSELL & TUTTLE, LLP, 806 S.W. BROADWAY, SUITE 600, PORTLAND, OR, 97205, US

(73) Assignee: Ford Global Technologies, LLC, Dearborn, MI (US)

(21) Appl. No.: 12/426,630

(22) Filed: Apr. 20, 2009

(51) Int. Cl. F02B 33/00

(52) U.S. Cl. 123/564; 123/565

(57) ABSTRACT

Methods and systems are provided for operating a vehicle engine including an intake and an exhaust, the engine further including a boosting device configured to provide a boosted air charge to the engine intake. One example method comprises, during an engine cold start, operating the engine with positive intake to exhaust valve overlap, driving a compressor of the boosting device at least partially via a motor to generate blow-through air flow into the engine exhaust through cylinders of the engine, and exothermically reacting a reductant with the blow-through air flow in the exhaust.

### FIELD

The present description relates generally to a method and system for operating a combustion engine.

### BACKGROUND/SUMMARY

Engine out cold-start emissions generated before light-off of an exhaust system catalytic converter may contribute a large percentage of the total exhaust emissions. To expedite the attainment of the catalyst light-off temperature, engine systems have been developed that may include thermactor systems, for example, port electric thermactor air systems (PETA). Such thermactor systems may be configured to inject secondary air into the exhaust manifold to thereby ignite the combustion of unburned fuel remaining in the exhaust. Additionally, or optionally, the injection of secondary air may be supplemented with additional fuel to substantially increase the exhaust temperature and thereby decrease the light-off time.

One example of such an engine system is provided by Busch in U.S. Pat. No. 7,231,760. Herein, the compressor of an exhaust gas turbocharger is used to compress a secondary air in addition to supercharging the engine. Additionally, a secondary pump may be provided to compress the secondary air. The two distinct compression processes are separated using two distinct flow paths, each bypassing the cylinders of the engine.

However, the inventors herein have recognized several potential issues with such an approach. As one example, the approach entails the use of secondary pumps, secondary flow paths, secondary ducting, and various check valves, to enable the transfer of the secondary air to the exhaust manifold while bypassing the engine cylinders. As such, this may add substantial cost and complexity to the system.

Thus, in one example, the above issue may be addressed by a method of operating a vehicle engine including an intake and an exhaust, the engine further including a boosting device configured to provide a boosted air charge to the engine intake, the method comprising, during an engine cold start, operating the engine with positive intake to exhaust valve overlap, driving a compressor of the boosting device at least partially via a motor to generate blow-through air flow into the engine exhaust through cylinders of the engine, and exothermically reacting a reductant with the blow-through air flow in the exhaust.

By directing the flow through the cylinders, it is possible to avoid and/or reduce the additional components used to bypass the cylinders. However, in an alternate example, such additional components may also be used in combination with the above approach, to provide still further airflow to the exhaust, if desired.

In one particular example, a vehicle engine may include a boosting device configured with an electric motor. During an engine cold start, for example before a catalyst light-off temperature is attained, a compressor of the boosting device (for example, a turbocharger) may be driven, at least partially, by the electric motor to enable fresh blow-through air to be injected into the exhaust manifold via the engine cylinders, such as during a positive intake to exhaust valve overlap. As such, the injection of the blow-through air may follow a cylinder combustion event where combusted gas is generated and expelled into the exhaust manifold. By directing air via the cylinder(s), fresh blow-through air at the end of an exhaust stroke (or beginning of a subsequent intake stroke) may follow the combusted exhaust gas into the exhaust manifold. An exhaust gas mixture may then be generated in the exhaust manifold by the mixing of the combusted exhaust gas with the blow-through air flow. An overall air-fuel ratio of the exhaust gas mixture may be maintained at a desired air-fuel ratio, (for example, around stoichiometry) by varying the amount of blow-through air flow generated and mixed with the combusted gas in the exhaust gas mixture. Additionally, a degree of richness of the combusted gas may be adjusted. For example, by increasing the richness of the combusted gas that is mixed with the blow-through air flow, a stoichiometric exhaust gas mixture may be generated. In another example, by increasing the amount of blow-through air that is mixed with rich-biased combusted gas, a stoichiometric exhaust gas mixture may be generated.

To further expedite catalyst light-off, a reductant may be exothermically reacted with the blow-through air flow in the exhaust. As one example, the reductant may be unburned fuel. As another example, the reductant may be combustion products of burned fuel, such as short chain hydrocarbons (HCs) and carbon-monoxide (CO). In one example, the reductant may be generated by a rich combustion event in the exhaust, the combustion event preceding the injection of the blow-through air. In another example, the reductant may be generated by a late injection into a cylinder during an exhaust stroke following a combustion event in the cylinder. For example, the late injection may be performed at least partially during the valve overlap.

In this way, by providing an oxygen-rich air supply (e.g., the fresh blow-through air flow) to the exhaust manifold, unburned fuel or other reductants present therein, may be rapidly combusted or exothermically reacted, thereby increasing the exhaust temperature, and consequently, the catalyst temperature. By rapidly increasing the catalyst temperature, the catalyst light-off time may be decreased and the quality of emissions may be improved.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic depiction of a vehicle system including an engine and an associated exhaust after-treatment system.

FIG. 2 shows a partial engine view.

FIG. 3 shows a map depicting engine positive intake to exhaust valve overlap.

FIGS. 4-5 show high level flow charts illustrating routines that may be implemented for expediting attainment of a catalyst light-off temperature.

### DETAILED DESCRIPTION

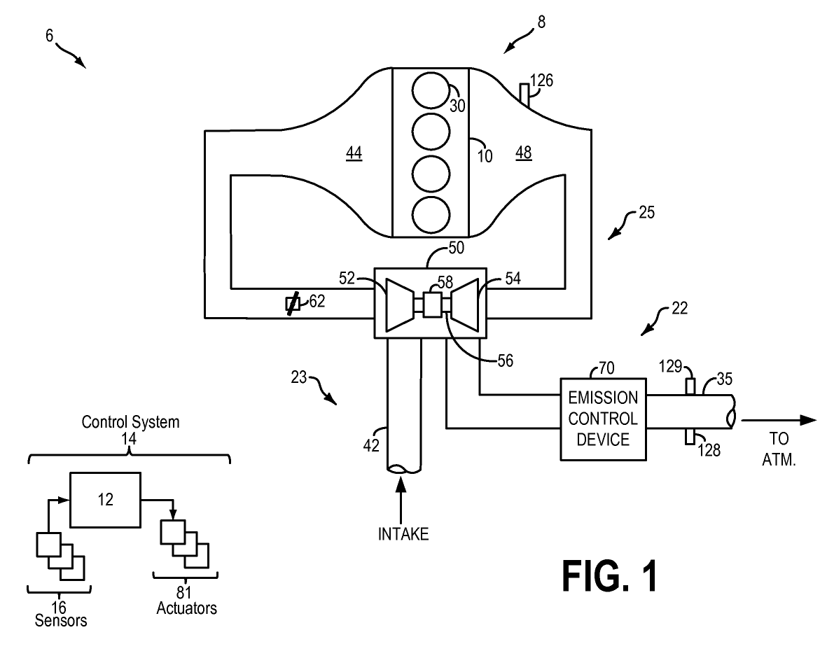

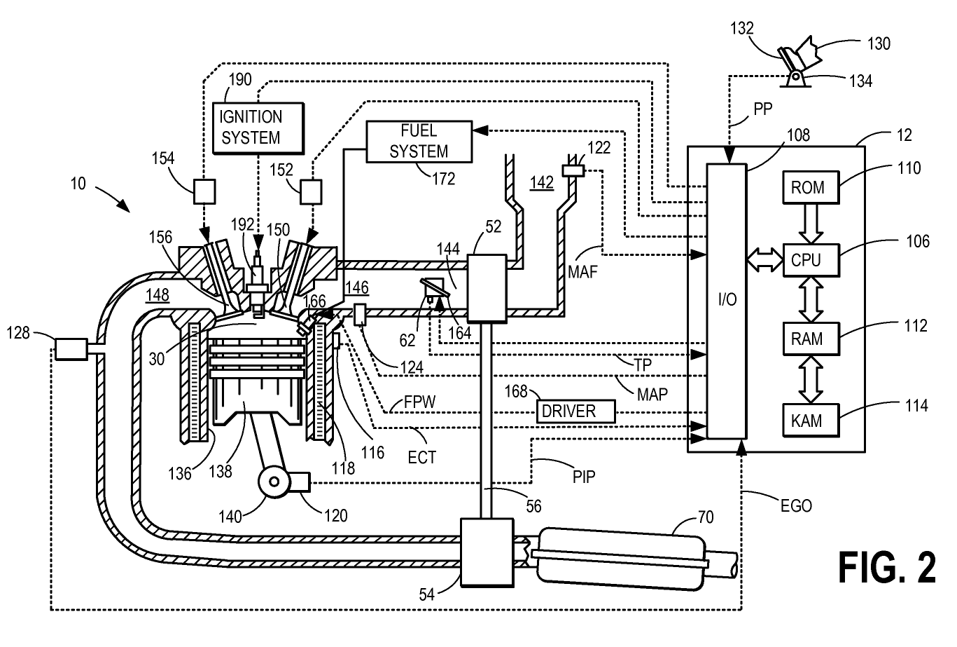

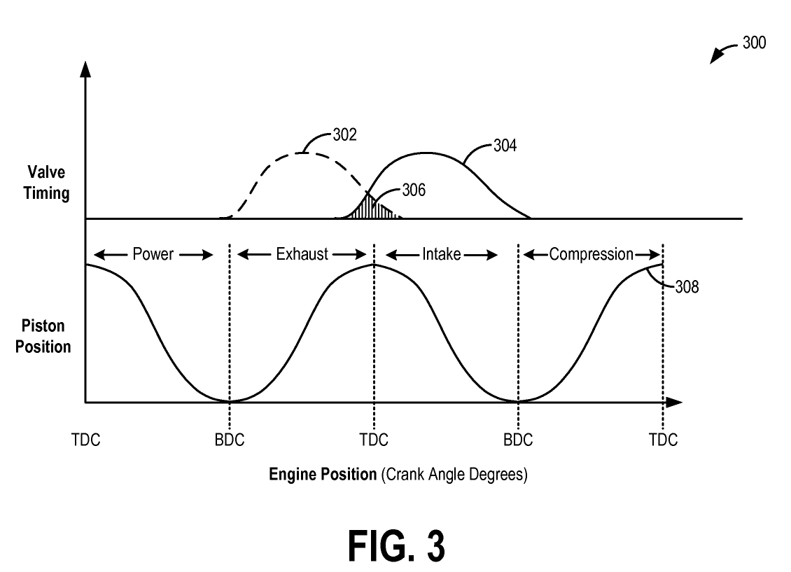

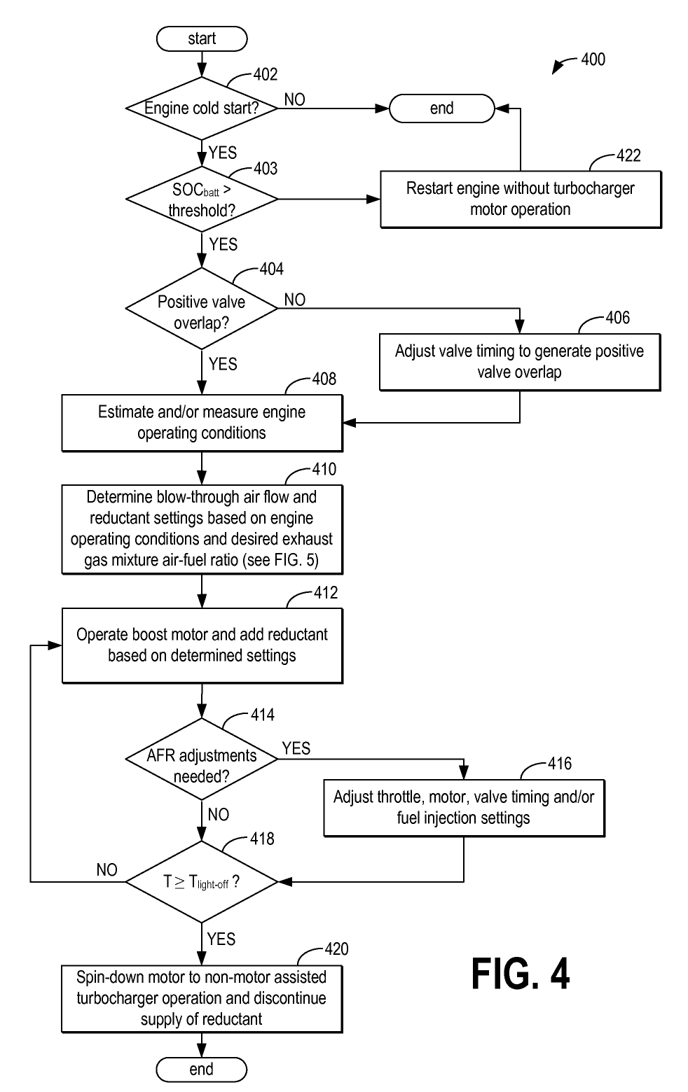

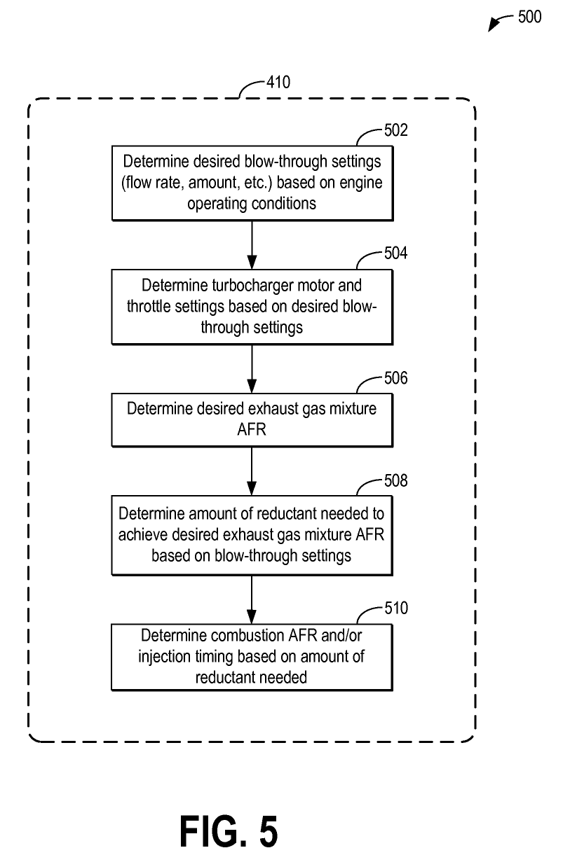

The following description relates to systems and methods for reducing the amount of time needed for a catalyst light-off temperature to be attained in an exhaust after-treatment system coupled to a vehicle engine, as depicted in FIGS. 1-2. By supplying a boosted aircharge through the engine cylinders during positive valve overlap (as depicted in FIG. 3), and by combining the boosted aircharge with a reductant, an exothermic reaction may be generated in the engine exhaust to substantially increase the exhaust temperature. An engine controller may be configured to perform a control routine, such as those depicted in FIGS. 4-5, during an engine cold start, to generate fresh blow-through air flow through the cylinders by driving an engine boosting device (such as a turbocharger). The controller may further supplement the boosted air charge with additional reductant, such as additional unburned fuel, to perform the exothermic reaction in the exhaust manifold. By increasing the exhaust temperature, and expediting attainment of a catalyst light-off temperature, the quality of vehicle cold-start emissions may be significantly improved.

FIG. 1 shows a schematic depiction of a vehicle system 6. The vehicle system 6 includes an engine system 8 coupled to an exhaust after-treatment system 22. The engine system 8 may include an engine 10 having a plurality of cylinders 30. Engine 10 includes an engine intake 23 and an engine exhaust 25. Engine intake 23 includes a throttle 62 fluidly coupled to the engine intake manifold 44 via an intake passage 42. The engine exhaust 25 includes an exhaust manifold 48 eventually leading to an exhaust passage 35 that routes exhaust gas to the atmosphere. Throttle 62 may be located in intake passage 42 downstream of a boosting device, such as turbocharger 50, or a supercharger. Turbocharger 50 may include a compressor 52, arranged between intake passage 42 and intake manifold 44. Compressor 52 may be at least partially powered by exhaust turbine 54, arranged between exhaust manifold 48 and exhaust passage 35. Compressor 52 may be coupled to exhaust turbine 54 via shaft 56. Compressor 52 may also be at least partially powered by an electric motor 58. In the depicted example, electric motor 58 is shown coupled to shaft 56. However, other suitable configurations of the electric motor may also be possible. In one example, the electric motor 58 may be operated with stored electrical energy from a system battery (not shown) when the battery state of charge is above a charge threshold. By using electric motor 58 to operate turbocharger 50, for example at engine start, an electric boost (e-boost) may be provided to the intake aircharge. In this way, the electric motor may provide a motor-assist to operate the boosting device. As such, once the engine has run for a sufficient amount of time (for example, a threshold time), the exhaust gas generated in the exhaust manifold may start to drive exhaust turbine 54. Consequently, the motor-assist of the electric motor may be decreased. That is, during turbocharger operation, the motor-assist provided by the electric motor 52 may be adjusted responsive to the operation of the exhaust turbine.

Engine exhaust 25 may be coupled to exhaust after-treatment system 22 along exhaust passage 35. Exhaust after-treatment system 22 may include one or more emission control devices 70, which may be mounted in a close-coupled position in the exhaust passage 35. One or more emission control devices may include a three-way catalyst, lean NOx filter, SCR catalyst, etc. The catalysts may enable toxic combustion by-products generated in the exhaust, such as NOx species, unburned hydrocarbons, carbon monoxide, etc., to be catalytically converted to less-toxic products before expulsion to the atmosphere. However, the catalytic efficiency of the catalyst may be largely affected temperature by the temperature of the exhaust gas. For example, the reduction of NOx species may require higher temperatures than the oxidation of carbon monoxide. Unwanted side reactions may also occur at lower temperatures, such as the production of ammonia and N₂O species, which may adversely affect the efficiency of exhaust treatment, and degrade the quality of exhaust emissions. Thus, catalytic treatment of exhaust may be delayed until the catalyst(s) have attained a light-off temperature. Additionally, to improve the efficiency of exhaust after-treatment, it may be desirable to expedite the attainment of the catalyst light-off temperature. As further elaborated herein with reference to FIGS. 4-5, an engine controller may be configured to inject blow-through air flow into the exhaust after-treatment system, through the cylinders, during an engine cold start, to thereby reduce the light-off time. The air flow, performed during a positive intake to exhaust valve overlap period (as shown in FIG. 3), may enable fresh blow-through air to be mixed with combusted exhaust gas and generate an exhaust gas mixture in the exhaust manifold. The blow-through air flow may provide additional oxygen for the catalyst's oxidizing reaction. Furthermore, the air flow may pre-clean the extra-rich exhaust from the cold engine, and help bring the catalytic converter quickly up to an operating temperature.

Exhaust after-treatment system 22 may also include hydrocarbon retaining devices, particulate matter retaining devices, and other suitable exhaust after-treatment devices (not shown). It will be appreciated that other components may be included in the engine such as a variety of valves and sensors, as further elaborated in the example engine of FIG. 2.

The vehicle system 6 may further include control system 14. Control system 14 is shown receiving information from a plurality of sensors 16 (various examples of which are described herein) and sending control signals to a plurality of actuators 81 (various examples of which are described herein). As one example, sensors 16 may include exhaust gas sensor 126 (located in exhaust manifold 48), temperature sensor 128, and pressure sensor 129 (located downstream of emission control device 70). Other sensors such as pressure, temperature, air/fuel ratio, and composition sensors may be coupled to various locations in the vehicle system 6, as discussed in more detail herein. As another example, the actuators may include fuel injectors (not shown), a variety of valves, pump 58, and throttle 62. The control system 14 may include a controller 12. The controller may receive input data from the various sensors, process the input data, and trigger the actuators in response to the processed input data, based on instruction or code programmed therein, corresponding to one or more routines. An example control routine is described herein with reference to FIGS. 4-5.

FIG. 2 depicts an example embodiment of a combustion chamber or cylinder of internal combustion engine 10. Engine 10 may be controlled at least partially by a control system including controller 12 and by input from a vehicle operator 130 via an input device 132. In this example, input device 132 includes an accelerator pedal and a pedal position sensor 134 for generating a proportional pedal position signal PP. Cylinder (i.e. combustion chamber) 30 of engine 10 may include combustion chamber walls 136 with piston 138 positioned therein. Piston 138 may be coupled to crankshaft 140 so that reciprocating motion of the piston is translated into rotational motion of the crankshaft. Crankshaft 140 may be coupled to at least one drive wheel of the passenger vehicle via a transmission system. Further, a starter motor may be coupled to crankshaft 140 via a flywheel to enable a starting operation of engine 10.

Cylinder 30 can receive intake air via a series of intake air passages 142, 144, and 146. Intake air passage 146 can communicate with other cylinders of engine 10 in addition to cylinder 30. In some embodiments, one or more of the intake passages may include a boosting device such as a turbocharger or a supercharger. For example, FIG. 2 shows engine 10 configured with a turbocharger including a compressor 52 arranged between intake passages 142 and 144, and an exhaust turbine 54 arranged along exhaust passage 148. Compressor 52 may be at least partially powered by exhaust turbine 54 via a shaft 56. However, in other examples, such as where engine 10 is provided with a supercharger, exhaust turbine 54 may be optionally omitted, where compressor 52 may be powered by mechanical input from a motor or the engine. Further still, shaft 56 may be coupled to an electric motor (as depicted in FIG. 1) to provide an electric boost, as needed. A throttle 62 including a throttle plate 164 may be provided along an intake passage of the engine for varying the flow rate and/or pressure of intake air provided to the engine cylinders. For example, throttle 62 may be disposed downstream of compressor 52 as shown in FIG. 2, or may be alternatively provided upstream of compressor 52.

Exhaust passage 148 can receive exhaust gases from other cylinders of engine 10 in addition to cylinder 14. Exhaust gas sensor 128 is shown coupled to exhaust passage 148 upstream of emission control device 70. Sensor 128 may be any suitable sensor for providing an indication of exhaust gas air/fuel ratio such as a linear oxygen sensor or UEGO (universal or wide-range exhaust gas oxygen), a two-state oxygen sensor or EGO (as depicted), a HEGO (heated EGO), a NOx, HC, or CO sensor. Emission control device 70 may be a three way catalyst (TWC), NOx trap, various other emission control devices, or combinations thereof.

Each cylinder of engine 10 may include one or more intake valves and one or more exhaust valves. For example, cylinder 30 is shown including at least one intake poppet valve 150 and at least one exhaust poppet valve 156 located at an upper region of cylinder 30. In some embodiments, each cylinder of engine 10, including cylinder 30, may include at least two intake poppet valves and at least two exhaust poppet valves located at an upper region of the cylinder.

Intake valve 150 may be controlled by controller 12 via actuator 152. Similarly, exhaust valve 156 may be controlled by controller 12 via actuator 154. During some conditions, controller 12 may vary the signals provided to actuators 152 and 154 to control the opening and closing of the respective intake and exhaust valves. The position of intake valve 150 and exhaust valve 156 may be determined by respective valve position sensors (not shown). The valve actuators may be of the electric valve actuation type or cam actuation type, or a combination thereof. The intake and exhaust valve timing may be controlled concurrently or any of a possibility of variable intake cam timing, variable exhaust cam timing, dual independent variable cam timing or fixed cam timing may be used. Each cam actuation system may include one or more cams and may utilize one or more of cam profile switching (CPS), variable cam timing (VCT), variable valve timing (VVT) and/or variable valve lift (VVL) systems that may be operated by controller 12 to vary valve operation. For example, cylinder 30 may alternatively include an intake valve controlled via electric valve actuation, and an exhaust valve controlled via cam actuation including CPS and/or VCT. In other embodiments, the intake and exhaust valves may be controlled by a common valve actuator or actuation system, or a variable valve timing actuator or actuation system. The engine may further include a cam position sensor whose data may be merged with the crankshaft position sensor to determine an engine position and cam timing.

Cylinder 30 can have a compression ratio, which is the ratio of volumes when piston 138 is at bottom center to top center. Conventionally, the compression ratio is in the range of 9:1 to 10:1. However, in some examples where different fuels are used, the compression ratio may be increased.

In some embodiments, each cylinder of engine 10 may include a spark plug 192 for initiating combustion. Ignition system 190 can provide an ignition spark to combustion chamber 30 via spark plug 192 in response to spark advance signal SA from controller 12, under select operating modes. However, in some embodiments, spark plug 192 may be omitted, such as where engine 10 may initiate combustion by auto-ignition or by injection of fuel as may be the case with some diesel engines.

In some embodiments, each cylinder of engine 10 may be configured with one or more fuel injectors for providing fuel thereto. As a non-limiting example, cylinder 30 is shown including fuel injector 166 coupled directly to cylinder 30. Fuel injector 166 may inject fuel directly therein in proportion to the pulse width of signal FPW received from controller 12 via electronic driver 168. In this manner, fuel injector 166 provides what is known as direct injection (hereafter referred to as “DI”) of fuel into combustion cylinder 30. While FIG. 2 shows injector 166 as a side injector, it may also be located overhead of the piston, such as near the position of spark plug 192. Alternatively, the injector may be located overhead and near the intake valve. Fuel may be delivered to fuel injector 166 from high pressure fuel system 172 including a fuel tank, fuel pumps, and a fuel rail. Alternatively, fuel may be delivered by a single stage fuel pump at lower pressure. Further, while not shown, the fuel tank may have a pressure transducer providing a signal to controller 12.

It will be appreciated that in an alternate embodiment, injector 166 may be a port injector providing fuel into the intake port upstream of cylinder 30. It will also be appreciated that cylinder 30 may receive fuel from a plurality of injectors, such as a plurality of port injectors, a plurality of direct injectors, or a combination thereof.

Controller 12 is shown in FIG. 2 as a microcomputer, including microprocessor unit 106, input/output ports 108, an electronic storage medium for executable programs and calibration values shown as read only memory chip 110 in this particular example, random access memory 112, keep alive memory 114, and a data bus. Controller 12 may receive various signals from sensors coupled to engine 10, in addition to those signals previously discussed, including measurement of inducted mass air flow (MAF) from mass air flow sensor 122; engine coolant temperature (ECT) from temperature sensor 116 coupled to cooling sleeve 118; a profile ignition pickup signal (PIP) from Hall effect sensor 120 (or other type, such as a crankshaft position sensor) coupled to crankshaft 140; throttle position (TP) from a throttle position sensor (not shown); and absolute manifold pressure signal (MAP) from sensor 124. Engine speed signal, RPM, may be generated by controller 12 from signal PIP (or the crankshaft position sensor). Manifold pressure signal MAP from a manifold pressure sensor may be used to provide an indication of vacuum, or pressure, in the intake manifold. Storage medium read-only memory 110 can be programmed with computer readable data representing instructions executable by processor 106 for performing the methods described below as well as other variants that are anticipated but not specifically listed.

As described above, FIG. 2 shows only one cylinder of a multi-cylinder engine. As such each cylinder may similarly include its own set of intake/exhaust valves, fuel injector(s), spark plug, etc.

FIG. 3 shows a map 300 of valve timing and piston position with respect to an engine position. During an engine cold-start, an engine controller may be configured to operate an engine boosting device, such as a turbocharger, by actuating an electric motor, to provide a motor-assist to the turbocharger and to thereby inject fresh blow-through air into the exhaust manifold. The blow-through air flow may be injected through the engine cylinders while operating the engine with positive intake to exhaust valve overlap. The engine controller may use a map, such as map 300, to identify the positive valve overlap period.

As depicted, map 300 illustrates an engine position along the x-axis in crank angle degrees (CAD). Curve 308 depicts piston positions (along the y-axis), with reference to their location from top dead center (TDC) and/or bottom dead center (BDC), and further with reference to their location within the four strokes (intake, compression, power and exhaust) of an engine cycle. As indicated by sinusoidal curve 308, a piston gradually moves downward from TDC, bottoming out at BDC by the end of the power stroke. The piston then returns to the top, at TDC, by the end of the exhaust stroke. The piston then again moves back down, towards BDC, during the intake stroke, returning to its original top position at TDC by the end of the compression stroke.

Curves 302 and 304 depict valve timings for an exhaust valve (dashed curve 302) and an intake valve (solid curve 304) during a normal engine operation. As illustrated, an exhaust valve may be opened just as the piston bottoms out at the end of the power stroke. The exhaust valve may then close as the piston completes the exhaust stroke, remaining open at least until a subsequent intake stroke has commenced. In the same way, an intake valve may be opened at or before the start of an intake stroke, and may remain open at least until a subsequent compression stroke has commenced.

As a result of the timing differences between exhaust valve closing and intake valve opening, for a short duration, before the end of the exhaust stroke and after the commencement of the intake stroke, both intake and exhaust valves may be open. As such, this period wherein both valves may be open may be referred to as a positive intake to exhaust valve overlap 306 (or simply, positive valve overlap), represented by a hatched region at the intersection of curves 302 and 304. In one example, the positive intake to exhaust valve overlap 306 may be a default cam position of the engine present during an engine cold start.

As further elaborated herein, a blow-through air flow may be generated during the positive intake to exhaust overlap. During the exhaust stroke, as the exhaust valve opens, the combusted exhaust gases generated during a combustion event in the cylinder's power stroke may be exhausted. During the following intake stroke, as the intake valve opens, fresh blow-through air may enter the cylinder. By performing a boosted engine operation at engine cold start, during the intake stroke, as the intake valve opens, and before the exhaust valve closes, the increased pressure in the intake manifold, (which is greater than the exhaust pressure in the exhaust manifold due to the boost provided by the boosting device) may drive fresh air through the cylinder(s) to the exhaust manifold. In this way, fresh oxygen-rich blow-through air may flow into the exhaust manifold during the positive valve overlap, until the exhaust valve closes. The mixing of the fresh air with the combusted exhaust gases (from the combustion event in the preceding power stroke) in the exhaust manifold may then generate an exhaust gas mixture. The oxygen-rich exhaust gas mixture may react with reductants such as unburned fuel, CO, and short chain HCs in the exhaust to generate an exothermic reaction in the exhaust after-treatment system. In this way, the exhaust gas mixture may increase heat to an emission control device of the exhaust after-treatment system. In one example, the reaction may be generated upstream of the emission control device. In another example, the reaction may be generated in the emission control device. By performing an exothermic reaction in the engine exhaust manifold, the temperature of an emission control device catalyst may be rapidly raised and the catalyst light-off time may be reduced.

Now turning to FIG. 4, a routine 400 is described for performing a supplementary air injection operation during an engine cold start, while operating the engine with positive intake to exhaust overlap, in the vehicle system of FIG. 1. The routine enables the compressor of an engine intake boosting device to be driven, at least partially, via a motor (such as an electric motor) to generate blow-through air flow in the exhaust. Upon mixing with combusted exhaust gas (from a preceding combustion event), an oxygen-rich exhaust gas mixture may be generated in the exhaust manifold. The routine may further enable the blow-through air to be reacted with a reductant, such as additional unburned fuel or partial combustion products, in the exhaust. In doing so, exothermic events in the exhaust manifold may be promoted and an exhaust temperature may be rapidly increased, thereby reducing a catalyst light-off time.

At 402, an engine cold start condition may be confirmed. In one example, an engine cold start condition may include a catalyst temperature being below a threshold temperature (such as a light-off temperature). In another example, an engine cold start condition may include the vehicle having been in an engine-off condition for greater than a threshold time. If an engine cold start condition is not present, the routine may end. At 403, a battery state of charge may be estimated and it may be determined whether the state of charge is above a threshold. If the battery state of charge is below the threshold, the electrical energy stored in the battery may not suffice to operate a motor of the engine boosting device. Accordingly, at 422, the engine may be started without turbocharger operation. In one example, when the battery state of charge is below the threshold, no blow-through air flow may be generated. If the battery state of charge is above the threshold, then at 404, it may be determined whether a positive intake to exhaust valve overlap is present in a cylinder of the engine. As such, positive valve overlap may be the default cam position such that the positive valve overlap is present at the time of engine cold start. If a positive valve overlap is not determined at 404, then at 406, valve timings may be adjusted to generate the positive valve overlap. An engine controller may be configured to use a map, such as depicted in FIG. 3, to identify cam timings corresponding to the desired positive intake to exhaust valve overlap.

At 408, engine operating conditions may be estimated, and/or measured. As such, these may include, but not be limited to, engine temperature, engine coolant temperature, exhaust temperature, catalyst temperature, engine speed, manifold pressure, barometric pressure, etc. In one example, the catalyst temperature may be inferred from the exhaust temperature. In another example, the catalyst temperature and/or the exhaust temperature may be further compared to a threshold temperature, such as a catalyst light-off temperature, and a temperature difference may be determined.

At 410, based on the estimated engine operating conditions and/or a desired exhaust gas mixture air-fuel ratio, blow-through air flow settings, including an amount of air flow, and a flow rate, may be determined. As further elaborated with reference to FIG. 5, the blow-through air flow settings may be adjusted at least based on the catalyst temperature (and/or exhaust temperature) and the battery state of charge. Additionally, reductant settings for a reductant that is exothermically reacted with the blow-through air flow may be determined based on the engine operating conditions and the desired exhaust gas air-fuel ratio. In one example, the reductant may be generated by a late fuel injection following a combustion event in the exhaust. The late fuel injection may be performed during the positive valve overlap, alongside the blow-through air flow, to enable proper air-fuel mixing. Herein, the reductant settings may include a fuel injection amount and timing. In another example, the fuel injection may follow the blow-through air injection. For example, the fuel injection may be adjusted in a subsequent (for example, immediately subsequent) cylinder from the air injection.

In another example, the reductant may be generated by a rich combustion event in the exhaust before the generation of the blow-through air flow. Herein, reductant settings may include a degree of richness of the combustion event and/or a desired combustion air-fuel ratio, such that, upon mixing of the combusted gases with the blow-through air flow, an exhaust gas mixture of a desired air-fuel ratio is generated. In one example, as further elaborated herein with reference to FIG. 5, the blow-through air flow settings and reductant settings may be adjusted such that the overall air-fuel ratio in the exhaust (that is, of the exhaust gas mixture) may be maintained at or around stoichiometry.

At 412, the boost motor may be operated based on the blow-through air flow settings. For example, the motor may be adjusted based on the amount of blow-through air flow to drive the turbocharger compressor and generate the desired blow-through air flow. In one example, the boost motor may be operated following a threshold number of combustion events from the engine start. In another example, where the engine includes a starter for cranking the engine at engine start, and the starter further includes a starter motor, the boost motor may be operated after starter motor deactivation. For example, the boost motor may be operated using current generated by the starter motor deactivation. Additionally, the reductant may be added based on the settings determined at 410.

At 414, it may be determined whether any air-fuel ratio (AFR) adjustments are needed. In one example, the engine may include an air-fuel ratio sensor in the engine exhaust, such as an EGO sensor. Feedback from the air-fuel ratio sensor may be used to adjust the overall air-fuel ratio in the exhaust gas. The feedback may be used to perform further adjustments to the blow-through air flow settings (such as an amount of air), and the degree of richness in the engine exhaust. In one example, the adjustments made based on feedback from the air-fuel ratio sensor may be such that the overall air-fuel ratio oscillates around stoichiometry.

If air-fuel ratio adjustments are needed, then at 416, the degree of richness of the engine exhaust may be adjusted by adjusting at least one of a throttle setting, a boost motor setting, a degree of valve overlap and/or the amount of blow-through air flow. In one example, the overall air-fuel ratio may be adjusted by adjusting the amount of blow-through air. For example, to decrease the richness of the overall air-fuel ratio, the amount of fresh blow-through air in the exhaust gas mixture may be increased by increasing a degree of opening of the throttle. In another example, to increase the richness of the overall air-fuel ratio, the amount of fresh blow-through air in the exhaust gas mixture may be decreased by decreasing a degree of opening of the throttle. Additionally, or optionally, the amount of flow-through air may be increased or decreased by accordingly increasing or decreasing a speed of the boost motor. In yet another example, the degree of richness of the exhaust gas mixture may be adjusted by adjusting the air-fuel ratio of the combusted gases. The air-fuel ratio of the combusted gases may be adjusted by adjusting an amount of fuel injected during the combustion event and/or adjusting an amount of air drawn in during the intake stroke of the combustion event.

It will be appreciated that as the engine operation progresses, the exhaust gas generated in the exhaust manifold may start to drive the exhaust turbine. That is, once the engine has run for a sufficient amount of time (for example, a threshold time, or after a threshold number of combustion events have elapsed), the turbocharger compressor may be at least partially operated by the flow of exhaust through the exhaust turbine. Consequently, the motor-assist of the electric motor may be decreased. That is, during turbocharger operation, the motor-assist provided by the electric motor may be further adjusted responsive to the operation of the exhaust turbine. Specifically, to compensate for the fraction of blow-through air flow generated by the exhaust turbine, and to enable a net flow rate and/or amount of blow-through air to be maintained, the fraction of blow-through air flow generated by the electric motor may also be adjusted (for example, decreased) at 416. For example, in accordance with a decreased flow requirement, the speed settings of the electric motor may also be decreased.

At 418, it may be determined whether a threshold temperature has been reached in the engine exhaust. The threshold temperature may be a catalyst light-off temperature (T_{light-off}) or a threshold temperature range. In one example, an exhaust temperature may be measured and/or inferred and compared to the catalyst light-off temperature (T_{light-off}). In another example, a catalyst temperature may be compared to the catalyst light-off temperature. If the catalyst temperature is greater than the threshold temperature (herein, the catalyst light-off temperature T_{light-off}), then at 420, the boost motor may be spun down to a non motor-assisted boosting device operation setting (such as a basal or “idle” turbocharger setting). As such, at this setting, the turbocharger compressor may be substantially operated by the exhaust turbine only and no further blow-through air flow may be generated. Additionally, the supply of reductant may also be discontinued at 420. In contrast, if the catalyst light-off temperature has not been attained at 418, the routine may return to 412 and continue to operate the boost motor to generate the blow-through air flow.

Now turning to FIG. 5, a routine 500 is described for determining settings for the blow-though air flow and reductant, responsive to engine operating conditions. As such, the steps described in routine 500 may be performed as part of routine 400, specifically at 410.

At 502, based on the engine operating conditions (estimated at 408), the blow-through air settings may be determined. These may include, for example, an amount of fresh blow-through air to be injected and mixed with the combusted exhaust gas in the exhaust manifold, and/or a corresponding flow rate. The blow-through air flow air flow settings may be adjusted at least based on the catalyst temperature (and/or exhaust temperature) and the battery state of charge. In one example, when a temperature difference between the catalyst temperature and the threshold (light-off) temperature is relatively larger, more blow-through air flow may be generated. In contrast, when a temperature difference between the catalyst temperature and the threshold temperature is relatively smaller, less blow-through air flow may be generated. In another example, when the battery state of charge is below a threshold, no blow-through air flow may be generated (for example, to conserve battery charge).

At 504, based on the blow-through air flow settings (that is, rate and/or amount of air flow), the turbocharger electric motor and/or throttle settings may be determined. In one example, when a higher flow rate and a larger amount of blow-through air flow is determined, the throttle opening degree may be increased and/or the electric motor speed may be increased. In another example, when a lower flow rate and a lower amount of blow-through air is determined, the throttle opening degree may be decreased and/or the electric motor speed may be decreased.

At 506, an overall air-fuel ratio (AFR) desired in the exhaust gas mixture (that is, the mixture generated in the exhaust manifold upon the mixing of the fresh blow-through air with the combusted exhaust gases) may be determined, for example, based on the engine operating conditions. In one example, the overall air-fuel ratio may oscillate around stoichiometry. In another example, when the temperature difference between the exhaust temperature and the catalyst light-off temperature is larger (for example, larger than a threshold), the air-fuel ratio of the exhaust mixture may be adjusted to be more rich. In still another example, when the temperature difference between the exhaust temperature and the catalyst light-off temperature is smaller (for example, smaller than a threshold), the air-fuel ratio of the exhaust mixture may be adjusted to be less rich (for example, stoichiometric or slightly lean).

At 508, an amount of reductant to be reacted with the blow-through air to achieve the desired exhaust gas mixture air-fuel ratio is determined, at least based on the blow-through settings. In one example, the reductant may include a late fuel injection alongside the injection of blow-through air such that the air-fuel ratio of the blow-through air is rich-biased. As previously elaborated (at 410), in alternate examples, the reductant may be generated by a late fuel injection into a cylinder during an exhaust stroke following a combustion event in the cylinder, or a rich combustion event in the cylinder before the injection of the blow-through air flow.

At 510, based on the amount of reductant needed, a combustion air-fuel ratio, an injection volume and/or injection timing may be determined. In one example, if the desired exhaust gas mixture air-fuel ratio is rich-biased, the combustion air-fuel ratio may be adjusted to be more rich and/or a later injection timing (for example, later in the exhaust stroke) may be used. In another example, if the desired exhaust gas mixture air-fuel ratio is stoichiometric, the combustion air-fuel ratio may be adjusted to be less rich and/or an earlier injection timing may be used. In yet another example, if the desired exhaust gas mixture air-fuel ratio is lean-biased, the combustion air-fuel ratio may be adjusted to be stoichiometric and/or an earlier injection timing may be used.

In this way, by injecting blow-through air into the engine exhaust through the cylinders, and by supplementing the air injection with a fuel injection, a combustion reaction may be generated that increases the heat in an exhaust emission control device and expedites attainment of catalyst light-off temperatures. The air and fuel injection settings may be adjusted responsive to the catalyst temperature to achieve a desired exhaust gas mixture air-fuel ratio in the engine exhaust.

In this way, the electric motor of an engine boosting device may be advantageously used to generate a blow-through air flow to the exhaust manifold, during an engine cold start. By reacting the blow-through air with reductant, an exothermic reaction may be promoted in the exhaust manifold, thereby increasing the exhaust temperature. By rapidly increasing the exhaust temperature, the catalyst light-off time may be reduced, and the operation of an engine exhaust after-treatment system may be enabled at an earlier time. In doing so, the quality of engine emissions may be improved.

Note that the example control and estimation routines included herein can be used with various system configurations. The specific routines described herein may represent one or more of any number of processing strategies such as event-driven, interrupt-driven, multi-tasking, multi-threading, and the like. As such, various actions, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, functions, or operations may be repeatedly performed depending on the particular strategy being used. Further, the described operations, functions, and/or acts may graphically represent code to be programmed into computer readable storage medium in the control system

Further still, it should be understood that the systems and methods described herein are exemplary in nature, and that these specific embodiments or examples are not to be considered in a limiting sense, because numerous variations are contemplated. Accordingly, the present disclosure includes all novel and non-obvious combinations of the various systems and methods disclosed herein, as well as any and all equivalents thereof.

1. A method of operating a vehicle engine including an intake and an exhaust, the engine further including a boosting device configured to provide a boosted air charge to the engine intake, the method comprising,
during an engine cold start, operating the engine with positive intake to exhaust valve overlap, driving a compressor of the boosting device at least partially via a motor to generate blow-through air flow into the engine exhaust through cylinders of the engine, and exothermically reacting a reductant with the blow-through air flow in the exhaust.

2. The method of claim 1 further comprising, generating the reductant by rich combustion.

3. The method of claim 1 further comprising, generating the reductant by a late injection into a cylinder during an exhaust stroke following a combustion event in the cylinder.

4. The method of claim 1 further comprising maintaining an overall air-fuel ratio in the exhaust at a desired air-fuel ratio, the exhaust including the blow-through air flow.

5. The method of claim 4 wherein the motor is operated with stored electrical energy from a battery when a battery state of charge is above a threshold.

6. The method of claim 5 wherein driving the compressor at least partially via the motor includes, adjusting an amount of blow-through air flow at least based on a catalyst temperature and the battery state of charge via adjusting the motor.

7. The method of claim 5 wherein no blow-through air flow is generated when the battery state of charge is below the threshold.

8. The method of claim 4 wherein maintaining an overall air-fuel ratio in the exhaust includes adjusting a degree of richness in the exhaust based on at least one of a throttle setting, a motor setting, a degree of valve overlap, and/or an amount of blow-through air flow.

9. The method of claim 1 wherein the engine cold start condition includes at least one of a catalyst temperature being below a threshold temperature, and the vehicle having been in an engine-off condition for greater than a threshold time.

10. The method of claim 9 further comprising, spinning down the motor to a non motor-assisted boosting device operation when the catalyst temperature is greater than the threshold temperature, the threshold temperature being a catalyst light-off temperature.

11. A vehicle system, comprising:
an engine including an intake and an exhaust;
a starter including a starter motor, the starter configured to crank the engine at engine start;
an intake boosting device including a compressor, the compressor at least partially driven by a boost motor;
an emission control device in the engine exhaust; and
a computer readable storage medium having code therein, the medium comprising:
code for, operating with positive intake to exhaust valve overlap in a cylinder of the engine;
code for, during the positive valve overlap, operating the boost motor with stored electrical energy, the boost motor driving the compressor to generate fresh blow-through air flow from the engine intake to the engine exhaust through the cylinder of the engine, and mixing the blow-through air flow with combusted exhaust gas to generate an exhaust gas mixture in the engine exhaust, the exhaust gas mixture increasing heat to the emission control device; and
code for maintaining an overall air-fuel ratio of the exhaust gas mixture at a desired air-fuel ratio, the exhaust gas mixture including the blow-through air flow exothermically reacting with excess reductant.

12. The system of claim 11 further comprising a battery, wherein operating the boost motor with stored electrical energy includes operating the boost motor with stored electrical energy from the battery when a battery state of charge is above a threshold.

13. The system of claim 11 wherein operating the boost motor includes operating the boost motor following a threshold number of combustion events from engine start and/or following starter motor deactivation.

14. The system of claim 11 wherein operating the boost motor following starter motor deactivation includes operating the boost motor using current generated by the starter motor deactivation.

15. The system of claim 11 wherein during the positive valve overlap, an amount of blow-through air flow is adjusted at least based on a catalyst temperature and a battery state of charge and operating the boost motor includes adjusting the motor based on the amount of blow-through air flow.

16. The system of claim 15 wherein the reductant is generated by at least one of a rich combustion and a late injection following a combustion event, and wherein maintaining an overall air-fuel ratio of the exhaust gas mixture includes adjusting a degree of richness in the engine exhaust based on at least one of a throttle setting, a motor setting, a degree of valve overlap, and/or the amount of blow-through air flow.

17. The system of claim 16 further comprising an air-fuel ratio sensor, wherein adjusting the degree of richness further includes adjusting based on feedback from the air-fuel ratio sensor, such that the overall air-fuel ratio is at stoichiometry.

18. A method of operating an engine including an intake and an exhaust, the engine further including an intake boosting device, a compressor of the boosting device at least partially driven by a motor, the method comprising,
during an engine cold start, operating the motor with stored electrical energy, the motor driving the compressor to flow fresh air from the engine intake to the engine exhaust through concurrently open intake and exhaust valves of a cylinder of the engine, and mixing the flow of fresh air with combusted exhaust gas to generate a reaction, the reaction increasing heat to the emission control device.

19. The method of claim 18 wherein the combusted exhaust gas is rich.

20. The method of claim 18 further comprising a late fuel injection, wherein mixing the flow of fresh air includes mixing the flow of fresh air with the late injected fuel.

21. The method of claim 18 wherein the reaction is generated in the emission control device.

22. The method of claim 18 wherein the reaction is generated upstream of the emission control device.
